(19) United States
(12) Patent Application Publication
(10) Pub. No.: US 2006/0131461 A1
(43) Pub. Date: Jun. 22, 2006

(54) Reel for tape-like material with air evacuation for enhanced packing of the reeled material

(75) Inventors: Havard Hoelsaeter, Oslo (NO); Havard Holmedal, Oslo (NO); Bjarte Jegerstedt, Oslo (NO)

Correspondence Address: SCHIFF HARDIN, LLP;PATENT DEPARTMENT, 6600 SEARS TOWER, CHICAGO, IL, 60606-6473, US

(73) Assignee: Tandberg Storage ASA

(21) Appl. No.: 11/015,239

(22) Filed: Dec. 17, 2004

(51) Int. Cl. G11B 23/02; B65H 75/18

(52) U.S. Cl. 242/614; 242/324

(57) ABSTRACT

A reel for windable tape-like material has generally parallel flanges connected by a hub on which the tape-like material is to be wound in a tape pack. One of the flanges has an air evacuator built into it which includes an air passage in that flange and a low pressure generator that interacts with air at the exterior of the flange as the reel is rotated, for producing a pressure at the exterior of the flange that is lower than the pressure at the interior region. An air flow thus is produced from the interior region to the exterior of the flange, so that less air is entrained between successive layers of the tape-like material as the tape-like material is wound on the hub. The packing density of the hub thus is increased.

### BACKGROUND OF THE INVENTION

1. Field of the Invention The present invention is directed to a reel for winding tape-like material thereon, and in particular to a reel for winding magnetic recording tape thereon.

2. Description of the Prior Art For many applications, it is necessary to wind ribbon-like or tape-like material onto a reel. The ribbon-like or tape-like material may be of any type, such as cloth, plastic, paper or thin metal. The tape-like material is wound onto a central hub of a reel, and forms a ribbon pack or tape pack around the hub, between the flanges of the reel.

Particularly when the material is wound onto the hub at a high rotational speed of the reel, air becomes entrained between the successive winding layers in the pack, thereby adding volume to the pack and reducing the packing density. This is particularly a problem in the case of winding of magnetic recording tape, wherein such tape is wound (and unwound) at extremely high speeds. Since most tape cartridges must have a specified form factor (i.e., predetermined standardized dimensions) in order to be used in standardized tape drives, the size of the take-up reel cannot be arbitrarily enlarged to accommodate a larger tape pack. A tape pack that is wound with a smaller packing density, due to the presence of air entrained between the successive wound layers of tape, reduces the total length of tape that can be wound on the reel. This, in turn, reduces the total available tape area for data recording. In general, therefore, it is desirable to have as high a packing density as possible for the tape wound on the reel.

Moreover, in the case of high speed magnetic tape drives, there is also a desire to continually increase the winding speed, because the access time for data recorded at any location along the tape length is dependent on the amount of time required to unwind the tape from the supply reel and wind the tape onto the take-up reel to bring the desired location on the tape past the read head. Therefore, as tape drives operating at increasingly higher speeds are developed, the packing density problem will be even more exacerbated.

### SUMMARY OF THE INVENTION

An object of the present invention is to provide a reel for winding any type of ribbon-like or tape-like material thereon at high speeds, wherein the amount of air entrainment is reduced, and thus the packing density is increased.

This object is achieved in accordance with the present invention in a reel for windable ribbon-like or tape-like material having first and second flanges mounted on a hub generally parallel to and spaced from each other. One of the flanges has an air evacuator built into it. This built-in air evacuator is formed by an air passage proceeding through this flange communicating an interior space between the flanges with an exterior of the flange having the air evacuator. The air evacuator also includes a low pressure generator that interacts with air at the exterior of the flange having the air evacuator as that flange rotates, for producing, via the air passage, air pressure at the exterior of that flange that is lower than air pressure at the interior region. As the ribbon-like or tape-like material is wound onto the hub as the reel rotates, air flows from the interior region to the exterior, due to the aforementioned lower pressure at the exterior, and therefore less air is entrained between successive wound layers of the material.

In the preferred embodiment, the flange having the air evacuator built into it is partially covered by a flat, circular plate. This avoids air from being drawn by the air evacuator in the opposite direction from the intended direction, which would tend to equalize the pressures at the exterior of the flange and at the interior region, thereby reducing the efficiency of promoting air flow from the interior region to the exterior.

In one embodiment, the air evacuator is formed by a number of curved ribs disposed at the exterior side of the flange, proceeding radially along respective curved paths from a central region to a periphery of the flange. An annular channel is formed at the exterior side of this flange between the central region and a raised edge of the periphery, and the curved ribs connect the central region to this raised edge. As the reel is rotated, each rib has a leading face that interacts with the ambient air in the manner of a turbine blade. Behind each rib, at a trailing side thereof, a number of openings are disposed, collectively forming the aforementioned air passage. The interaction of each curved blade with the air as the reel is rotated produces a low pressure at the trailing side of each rib, thereby producing an air flow through the holes from the interior region of the reel between the flanges.

The aforementioned cover plate has a diameter that is slightly less than the diameter of the flange, so that an annular opening is present at the periphery of the flange, thereby allowing an “escape path” for the air that has been evacuated from the interior region of the reel.

In the further embodiment, the air evacuator is formed by a number of aerofoils disposed in the flange between the central region and a raised peripheral edge of the flange. Each aerofoil has a profile similar to that of an airplane wing, so that a low pressure region is formed at the trailing edge or side of each aerofoil. Again, a number of holes are disposed in the flange at this trailing edge, so that air is evacuated from the interior region of the reel to the exterior of this flange as the reel rotates. Again, a cover plate is provided , having a diameter that is slightly less than the diameter of the flange, thereby producing an annular opening for the evacuated air to escape.

Although the orientation of a tape cartridge containing the two reels on which the tape is wound in a magnetic recording system is arbitrary, the flange that is generally regarded as the “top flange” preferably has the aforementioned air evacuator built into it.

Although the tape reel with the air evacuator as described above can be used to particular advantage in the case of data storage using magnetic recording tapes, the reel with the air evacuator according to the invention can be used in any context wherein windable ribbon-like or tape-like material must be wound at a high speed onto a reel. Therefore, in the following discussion, the generic term “tape-like material” will be used to indicate any type of windable material in a form similar to a tape, ribbon or strip. Such material is not limited to magnetic recording tape, but can be any type of material such as cloth, plastic, metal, paper, etc.

### DESCRIPTION OF THE DRAWINGS

FIG. 1 is a top view, slightly in perspective, of a flange of a reel for tape-like material having components of an air evacuator in accordance with the present invention.

FIG. 2 is a top view, slight in perspective, of a reel for tape-like material having an air evacuator in accordance with the invention, with a cover plate in place.

FIG. 3 is a perspective view of the reel of FIG. 2 in operation, with the cover plate being indicated by outline so that the air flow can be indicated.

FIG. 4 is a bottom view of the reel of FIG. 3.

FIG. 5 is a perspective view of a further embodiment of a reel for tape-like material having an air evacuator in accordance with the invention.

### DESCRIPTION OF THE PREFERRED EMBODIMENTS

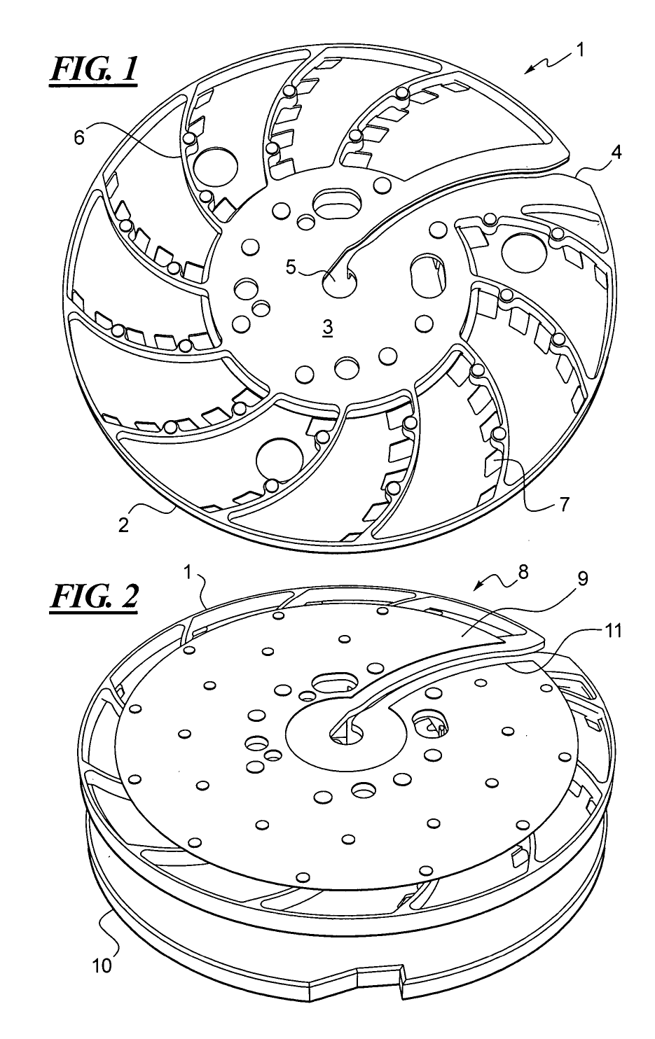

FIG. 1 shows a top view, slightly in perspective, of a flange 1 for a reel on which tape-like material is to be wound. The flange 1 has a raised peripheral edge 2 and a central region 3 between which an annular channel is formed. Below a central part of the central region 3, the reel has a hub on which the tape-like material is wound. During a loading or threading operation, the leading free end of the tape-like material 12 is brought through a channel 4, that opens at the raised peripheral edge 2, to a central opening 5 of the reel, where it is held as the tape-like material is wound.

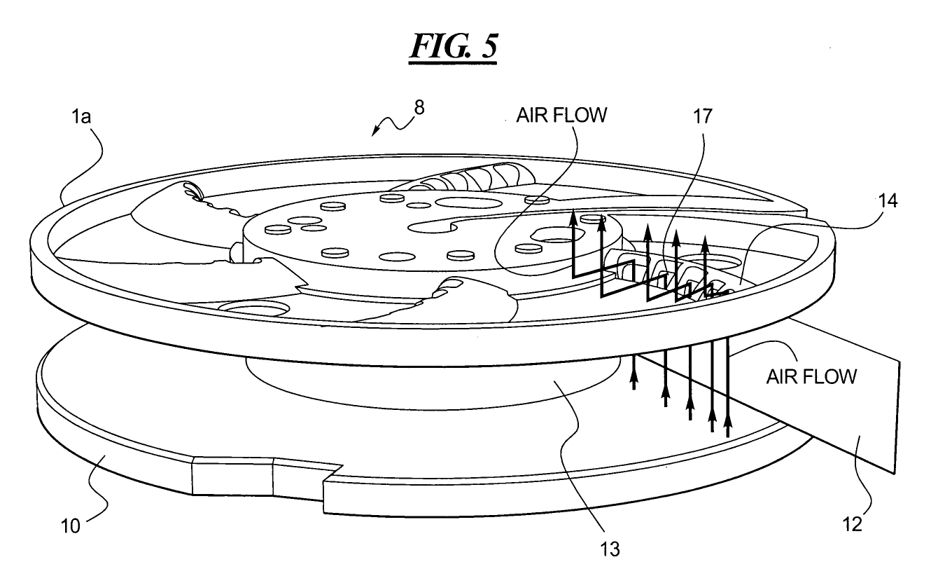

As best seen in FIG. 4, the tape-like material 12 is wound in a tape pack 13 around the hub (which is at the center at the tape pack 13 and therefore cannot be seen). In this winding operation, air becomes entrained between the successive layers of the wound tape-like material 12, causing a decrease in the otherwise available packing density of the tape pack 13. To reduce the amount of air that is present in the interior region of the reel between the flange 1 and the other flange 10, the flange 1 has an air evacuator built into it. The embodiment shown in FIG. 1, this air evacuator is formed by a number of curved ribs 6, proceeding radially from the central region 3 to the raised peripheral edge 2, in the channel therebetween. Each of these curved ribs has a number of holes 7 disposed at one side thereof, these holes 7 collectively forming an air passage.

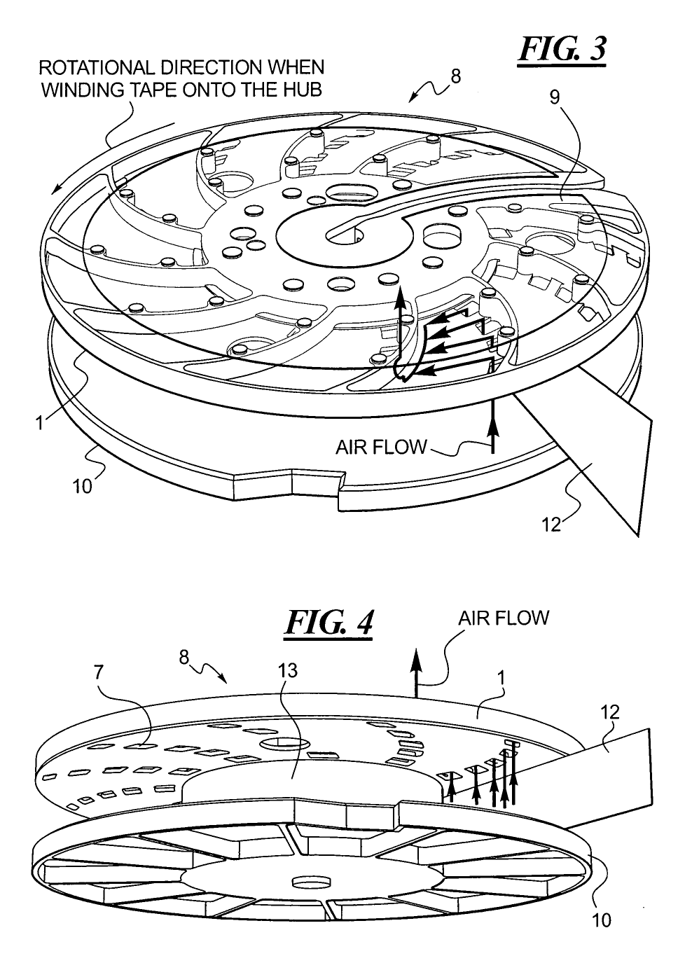

As shown in FIGS. 3 and 4, during rotation of the reel 8 to effect winding of the tape-like material 12 thereon, the holes 7 are disposed at a trailing side of each curved rib 6, with the leading side of each curved rib 6 encountering ambient air as the reel is rotated. The curved ribs 6 operate in the manner of turbine blades, creating a low pressure at the trailing side of each curved rib 6. As used herein, “low pressure” means a pressure that is lower than the air pressure prevailing in the interior region of the reel 8 between the flange 1 and the flange 10. This low pressure produces an air flow from the interior region to the exterior of the reel 8, as indicated by the arrow in FIGS. 3 and 4. This air flow reduces the “static” air in the interior region of the reel 8, so that less air is entrained between the successive layers of tape-like material 12 wound in the tape pack 13. As result, the tape pack 13 has an increased packing density.

As shown in FIG. 2, the air evacuator preferably also includes a cover plate 9 disposed over the curved ribs 6. The cover plate 9 has a diameter that is less than the diameter of the flange 1, so that an annular opening exists near the periphery of the flange 1. As shown in FIG. 3, this forms a passage to allow the air that has been evacuated from the interior region of the reel 8 to escape. If the cover plate 9 were not present, an equilibrium condition would tend to be produced between the exterior of the flange 1 and the interior region of the reel 8, thereby reducing the efficiency of the air evacuation. The cover plate 9, therefore, significantly enhances the efficiency of the overall operation.

A further embodiment of the air evacuator is shown in FIG. 3, wherein the top flange 1a has a number of aerofoils 14 built into it. Each aerofoil 14 is shaped in the manner of an airplane wing, and thus has a leading edge and a trailing edge. During rotation of the reel 8 for winding tape-like material 12 thereon, low pressure is again is produced at the trailing edge, at which the holes 17 are disposed, thereby again promoting evacuation of air from the interior region of the flange 8 to the exterior of the flange la, as indicated by the arrows in FIG. 5. As in the previous embodiment, the exterior side of the flange la preferably is covered by a cover plate (not specifically shown with this embodiment) having a diameter that is smaller than the diameter of the flange 1a.

In the context of magnetic recording tape cartridges, the actual spatial orientation assumed by the cartridge in the drive is arbitrary, since the drive can be essentially arbitrarily oriented, with a few restrictions. Nevertheless, a tape cartridge generally has a side or a surface that is called the “top surface,” and the flange 1 or 1a having the air evacuator built into it preferably is disposed next to this top surface of the cartridge, and thus can be regarded as the “top” flange of the reel 8. Under appropriate circumstances, however, there is no reason why the air evacuator could not be built into the bottom flange 10.

Although modifications and changes may be suggested by those skilled in the art, it is the intention of the inventors to embody within the patent warranted hereon all changes and modifications as reasonably and properly come within the scope of their contribution to the art.

We claim as our invention:

1. A reel for windable tape-like material comprising:
a first flange and a second flange generally parallel to and spaced from said first flange, said first and second flanges forming an interior region therebetween;
a central hub disposed in said interior region and connecting said first and second flanges, said hub being adapted to wind tape-like material thereon in a pack in said interior region as said hub and said first and second flanges co-rotate; and
an air evacuator built into one of said first and second flanges and including an air passage in said one of said flanges communicating said interior region with an exterior of said one of said flanges, and including a low pressure generator adapted to interact with air at said exterior as said one of said flanges rotates for producing, via said air passage, a pressure at said exterior that is lower than a pressure at said interior region for evacuating air from said interior region for reducing air between successive windings of said tape-like material in said pack.

2. A reel as claimed in claim 1 wherein said air evacuator further comprises a cover plate disposed at said exterior of said one of said flanges, said cover plate having a diameter that is less than a diameter of said one of said flanges, forming an annular opening at said exterior.

3. A reel as claimed in claim 1 wherein said one of said flanges, at said exterior, has a raised central region and a raised peripheral edge with an annular channel formed between said raised central region and said raised peripheral edge, and wherein said air evacuator comprises a plurality of curved ribs proceeding radially in said channel from said raised central region to said raised peripheral edge, each of said ribs having a leading side adapted to interact with ambient air as said one of said flanges rotates, and a trailing side at which said pressure is produced at said exterior that is lower than said pressure at said interior region, and wherein said one of said flanges has a plurality of openings therein disposed next to each of said trailing side, said plurality of openings collectively forming said air passage.

4. A reel as claimed in claim 1 wherein said one of said flanges, at said exterior, has a raised central region and a raised peripheral edge with a channel disposed between said raised central region and said raised peripheral edge, and wherein said air evacuator comprises a plurality of aerofoils proceeding radially in said channel from said raised central region to said raised peripheral edge, each of said aerofoils having a leading side adapted to interact with ambient air as said one of said flanges rotates, and a trailing side at which said pressure is produced at said exterior that is lower than said pressure at said interior region, and wherein said one of said flanges has a plurality of openings therein disposed next to each of said trailing sides, said plurality of openings collectively forming said air passage.

5. A reel as claimed in claim 1 wherein said first flange is a top flange and wherein said second flange is a bottom flange, and wherein said one of said flanges having said air evacuator is said top flange.

6. A method for improving the packing density of a pack of tape-like material wound on a hub of a reel having two generally parallel flanges connected by the hub, said method comprising the steps of:
building an air evacuator into one of said flanges for producing a lower pressure, as said reel is rotated, at an exterior of said one of said flanges compared to a pressure at an interior region between the flanges; and
rotating said reel for winding said tape-like material on said hub in said pack and evacuating air with said air evacuator, during said winding, from said interior region for reducing air entrained between successive layers of said tape-like material in said pack.
